(19) United States
(12) Patent Application Publication
(10) Pub. No.: US 2012/0068565 A1
(43) Pub. Date: Mar. 22, 2012

(54) Thermally decoupled bearing arrangement

(75) Inventors: Dieter Pfeil, Eurasburg (DE); Hans-Georg Scherer, Geretsried (DE); Gisela Rauh, Eurasburg (DE)

(73) Assignee: EagleBurgmann Germany GmbH & Co. KG, Wolfratshausen (DE)

(21) Appl. No.: 13/138,628

(22) PCT Filed: Mar. 11, 2010
(86) PCT No.: PCT/EP2010/001541

§ 371 Date: Dec. 8, 2011

(30) Foreign Application Priority Data
Mar. 25, 2009 (DE) 20 2009 004 160.3

(51) Int. Cl. F16C 17/22; H02K 49/00

(52) U.S. Cl. 310/103; 384/276

(57) ABSTRACT

The invention relates to a bearing arrangement for supporting a shaft (3), comprising a bushing (2) in which the shaft (3) is received, a circumferential ring gap (4) being present between the bushing (2) and the shaft (3), and the bushing (2) and the shaft (3) being made of materials having different thermal expansion coefficients, a connection arrangement (21) comprising a retaining element (8; 32, 33, 34) connected to the shaft (3) and a rotating bearing ring (7) in order to provide a centering support of the bushing (2) at the outer circumference (2b) thereof relative to the shaft (3), a stationary bearing ring (6, 6′) that is disposed radially outside of the bushing (2) and forms an axial sliding bearing (14) with the rotating bearing ring (7, 7′), and is characterized in that the connection arrangement (21) comprises a circumferential annular band element (9, 9′), wherein the annular band element (9, 9′) is connected to the rotating bearing ring (7, 7′) by means of a shrinkage connection in order to form an interconnected element (23), wherein the interconnected element (23) is inserted in a recess (8a; 32a) of the retaining element (8; 32) with a centering snug fit, and the annular band element (9, 9′) is connected to the retaining element (8; 32) in the axial direction (X-X) of the shaft (3).

The invention refers to a bearing arrangement for supporting a shaft, which is made of components having different thermal expansion coefficients, wherein the bearing arrangement comprises a thermal decoupling.

Bearing arrangements of different kinds are known from the state of the art. In particular in case of sliding bearings, it is often desired that a bearing insert of the sliding bearing is made of a wear-resistant material, e.g. a ceramic material, for reducing wear. When such a bearing insert co-operates with a shaft which is e.g. made of a steel material, problems may occur due to the thermal expansion coefficient of steel, which is much higher compared to that of the ceramic material. This may result in damages at the bearing arrangement.

From EP 0 563 437 A2, a bearing arrangement is known, in which a ceramic bushing is supported in a centering manner opposite to a shaft at an outer periphery of the bushing by means of a counter-bearing arrangement. This bearing arrangement basically has proven of value and is e.g. used for rotary pumps. Currently, however, increased requirements concerning the load capacity arose, and in particular the diameters of the shafts are made larger due to the high demand for larger equipment. Further, speed-controlled machines are more and more used, such that different duty points with different heat generation occur due to the speed control. Therewith, it is not possible to adapt the bearing arrangement for just one duty point.

It is therefore an object underlying the present invention to provide a bearing arrangement which secures a safe operation also upon regular speed changes of a shaft while having a simple structure and being manufactured easily and at low costs.

This object is solved by a bearing arrangement having the features of claim 1. The sub-claims comprise advantageous further developments of the invention.

The inventive bearing arrangement having the features of claim 1 has the advantage that it enables a thermal decoupling at the bearing, such that the individual components of the bearing arrangement can be made of materials having different thermal expansion coefficients. Therewith, the materials for the individual components can be adapted optimally to the respective requirements. According to the invention, a structure of the bearing arrangement can be very simple and cost-effective. According to the invention, this is achieved by shrink-fitting a band element onto an outer periphery of a rotating bearing ring such that a shrinkage connection is provided between the band element and the rotating bearing ring. Thus, the rotating bearing ring together with the shrink-fitted band element forms an interconnected element which is inserted into a recess of a retaining ring with a centering snug-fit. According to the invention, a centering snug-fit is a fit having no tolerance or a slight tolerance in the order of μm. Therewith, no press-fit may be present. The interconnected element may thus be inserted into and removed from the recess of the retaining ring manually. The band element is connected to the retaining ring by means of an axial connection. Herein, the interconnected element is at least partially surrounded by the retaining element in the radial direction, wherein the thermal decoupling between the interconnected element and the retaining element is enabled due the insertion of the interconnected element into the retaining element with a centering snug-fit. A stationary bearing ring and a rotating bearing ring form an axial sliding bearing. Therewith, undesired alterations of the running surface positions at the axial sliding bearing due to thermal alterations can be compensated according to the invention. Therewith, a damage of the running surfaces by a so-called edge loading can be prevented.

Particularly preferred, the stationary bearing ring additionally has a sliding surface that is directed radially inwardly, in order to form a radial sliding bearing together with the bushing that surrounds the shaft. Therewith, a radial sliding bearing and an axial sliding bearing can simultaneously be provided at the stationary bearing ring. Due to this multiple surface support at the stationary bearing ring, in particular the number of components can be reduced and a compact bearing arrangement can be provided.

Particularly preferred, the band element is formed symmetrically with respect to an axis disposed perpendicular with respect to a center axis of the shaft. Therewith, it is guaranteed that a constant alteration of the dimensions occur upon temperature changes at the band element. In this context, the band element preferably comprises a large bevel at the two edge portions directed radially outwardly.

Particularly preferred, the bearing arrangement is formed as a twin bearing arrangement and therewith comprises two rotating bearing rings and two stationary bearing rings. Therewith, the shaft can be supported at two mutually spaced regions. Preferably, the rotating bearing rings are arranged at stationary bearing ring sides facing each other in the axial direction for this purpose. In other words: In the axial direction, the rotating bearing rings are arranged between the stationary bearing rings. As an alternative, the rotating bearing rings are arranged at stationary bearing ring sides facing away from each other in the axial direction. In other words: In the axial direction, the stationary bearing rings are arranged between the rotating bearing rings.

Further, the present invention relates to a magnetic coupling including the inventive bearing arrangement. Magnetic couplings are preferably used in speed-controlled machines, in particular in pumps.

In the following, the present invention is described in detail on the basis of preferred embodiments in connection with the accompanying drawing, in which:

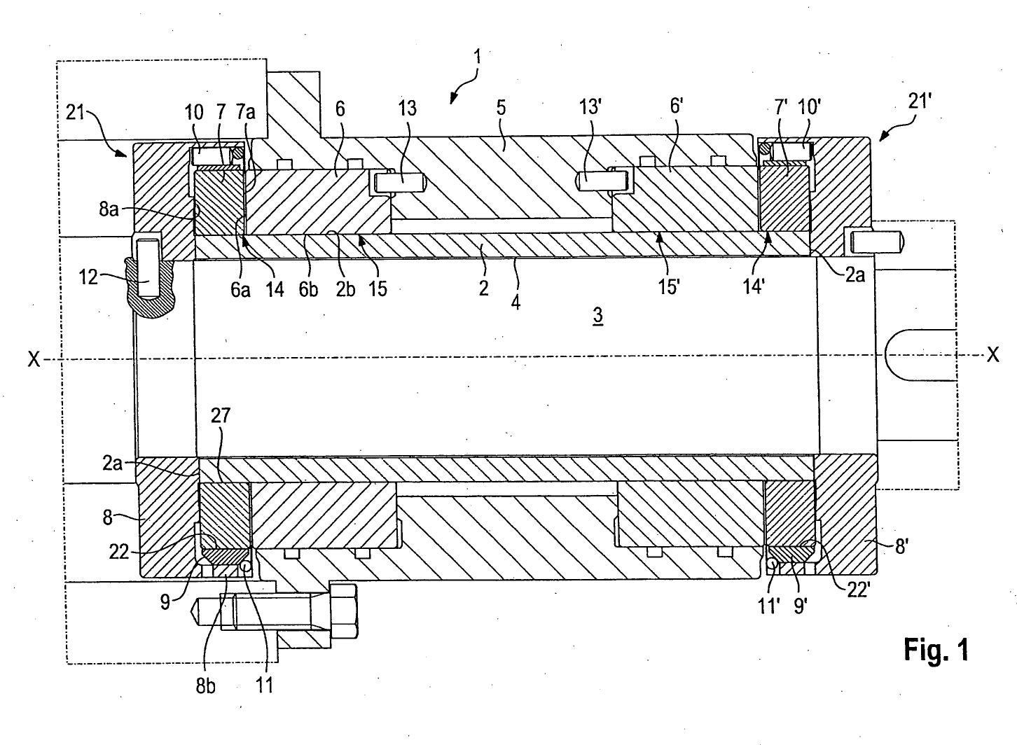

FIG. 1 shows a schematic sectional view of a bearing arrangement according to a first embodiment of the invention,

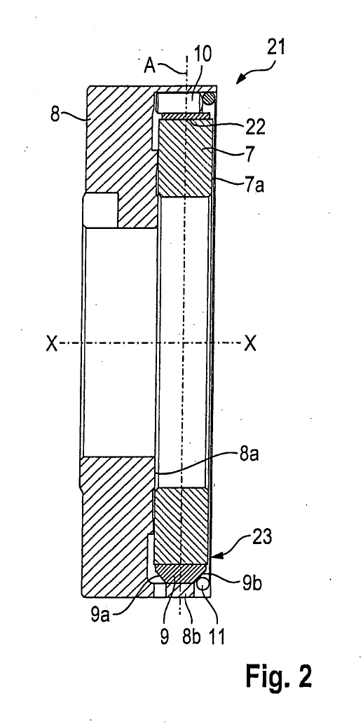

FIG. 2 shows a schematic sectional view of a connection arrangement of FIG. 1,

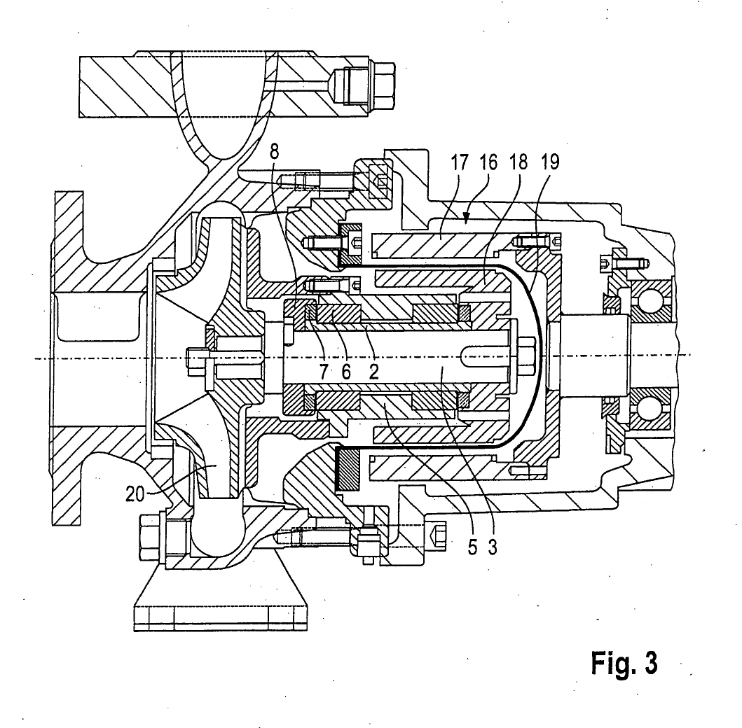

FIG. 3 shows a schematic sectional view of a rotary pump which uses a bearing arrangement according to FIG. 1, and

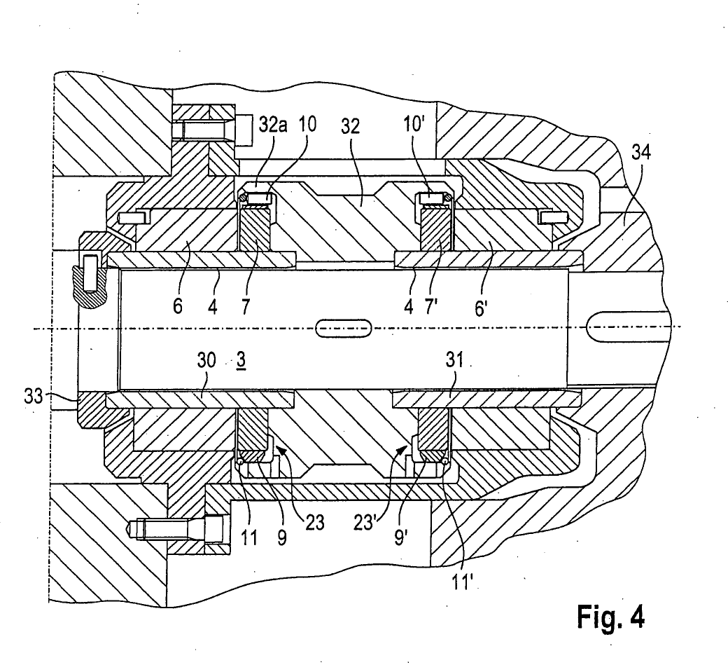

FIG. 4 shows a schematic sectional view of a bearing arrangement according to a second embodiment of the invention.

In the following, a bearing arrangement 1 according to a first embodiment of the invention is described in detail with reference to FIGS. 1 to 3. As is discernible from FIG. 1, the bearing arrangement 1 comprises a cylindrical bushing 2 in which a shaft 3 is arranged. A ring gap 4 is provided between the bushing 2 and the shaft 3, such that a radial distance is present between the bushing 2 and the shaft 3. The dimension of the ring gap 4 is selected such that a thermal expansion behaviour of the shaft 3 is considered, since the shaft 3 and the bushing 2 are made of different materials. In the present embodiment, the shaft is made of a steel material and the bushing is made of a ceramic material (SiC).

The bearing arrangement 1 of the shown embodiment serves to simultaneously support the shaft 3 axially as well as radially. In this case, the bearing arrangement 1 is provided as a twin bearing for supporting the shaft 3 at two mutually spaced regions. For this purpose, the bearing arrangement comprises a pair of axial sliding bearings 14, 14′ and a pair of radial sliding bearings 15, 15′. The axial sliding bearings 14, 14′ respectively comprise a rotating bearing ring 7, 7′ as well as a stationary bearing ring 6, 6′. The radial sliding bearings 15, 15′ are formed in the radial direction of the shaft between the stationary bearing ring 6, 6′ and an outer boundary 2b of the bushing 2. As is discernible from FIG. 1, the two stationary bearing rings 6, 6′ are attached to a housing part 5 by means of pins 13, 13′.

The shaft 3 is connected to the bushing 2 at the two opposing ends of the bushing 2 by means of connection or centering arrangements 21, 21′. The connection arrangements 21, 21′ serve to concentrically position the bushing 2 relative to the shaft 3. Each of the connection arrangements 21, 21′ comprises an annular retaining element 8, 8′ which is connected to the shaft 3 by means of pins 12. Further, also the rotating bearing rings 7, 7′ are part of the connection arrangements 21, 21′. As is in particular discernible from FIG. 2, the connection arrangements 21, 21′ further comprise an additional annular band element 9, 9′. The annular band element 9, 9′ is formed symmetrically with respect to an axis A, wherein the axis A is perpendicular to a center axis or rotation axis X-X of the shaft 3. The annular band element 9, 9′ is made of a metallic material and is respectively shrunk-fit onto the rotating bearing rings 7, 7′ by means of a shrinkage connection 22, 22′, which bearing rings are made of a ceramic material. Therewith, the rotating bearing rings 7, 7′ and the annular band elements 9, 9′ respectively form an interconnected element 23 (FIG. 2). The annular band element 9, 9′ is connected to the annular retaining element 8, 8′ in the axial direction through a fixing pin 10, 10′. As is shown in FIG. 2, the annular retaining element 8 has a recess 8a which is delimited by an annular rim portion 8b in a radially outward direction. Herein, the interconnected element 23, comprising the rotating bearing ring 7 and the annular band element 9, is inserted into the recess 8a with a centering snug-fit, and is connected to the annular retaining element 8 in the axial direction only by the fixing pin 10. Therewith, the rotation of the shaft 3 is transmitted through the annular retaining element 8, the fixing pin 10 and the annular band element 9 to the rotating bearing ring 7. The rotating bearing ring 7, at the inner periphery thereof, is still connected to the bushing 2 through a connection 27, in particular a centering snug-fit, wherein the bushing 2 is preferably clamped in an axial direction between the retaining elements 8, 8′. Therewith, the bushing 2 is centered at the shaft 3 by means of the connection arrangement 21, such that the shaft 3 and the bushing 2 can be made of materials having different thermal expansion coefficients without any problem.

The annular band element 9 further comprises large bevels 9a, 9b at its edge portions directed radially outwardly, wherein these bevels are also formed symmetrically with respect to the axis A. For attaching the interconnected element 23, a snap ring 11 is provided at the bevel 9b of the annular band element 9, which snap ring is retained in a recess in the rim portion 8b.

Therewith, a thermal decoupling between the components having different thermal expansion coefficients can be achieved according to the invention. Besides the shaft 3, also the annular retaining element 8 as well as the annular band element 9 are made of a metallic material. Contrary thereto, the rotating bearing ring 7 and the bushing 2 are made of a ceramic material. Consequently, the rotating bearing 7 does not react with a tipping when the temperature changes, which can result in the wear occurring in the state of the art at the axial sliding surfaces 7a, 6a of the axial sliding bearings 14, 14′. Changes of the tension profile in the shrinkage connection 22 between the annular band element 9 and the rotating bearing ring 7 can be compensated by the interconnected element 23 being inserted with the centering snug-fit. Due to the symmetric design of the annular band element 9 with respect to the axis A, in particular, no tipping of the rotating bearing ring 7 occurs upon different thermal expansions of the individual components.

FIG. 3 shows the use of the inventive bearing arrangement 1 in a pump. The pump comprises a magnetic coupling 16 including driving magnets 17 and driven magnets 18. A split cup 19 is provided between the driving magnets 17 and the driven magnets 18. The driven magnets 18 are herein connected to the shaft 3. A pump wheel is designated with reference numeral 20. The inventive bearing arrangement 1 assumes the axial as well as the radial support of the shaft 3, wherein two bearing surfaces, i. e. one bearing surface in the axial direction and one bearing surface in the radial direction, are provided at the stationary bearing rings 6, 6′.

FIG. 4 shows a bearing arrangement 1 according to a second embodiment of the invention, wherein identical or functionally identical components have the same reference numerals as in the first embodiment. The bearing arrangement 1 of the second embodiment substantially corresponds to that of the first embodiment, wherein the arrangement of the stationary bearing rings 6, 6′ with respect to the rotating bearing rings 7, 7′ is reversed compared to the first embodiment. In the second embodiment, the rotating bearing rings 7, 7′ are arranged at sides of the stationary bearing rings 6, 6′ facing away from each other in the axial direction. Further, no continuous bushing is provided in the second embodiment, but two separate bushings 30, 31. The two bushings 30, 31 are connected to each other through an intermediate element 32. Further, the first bushing 30 is connected to the shaft 3 through a retaining element 33 and the second bushing 31 is connected to the shaft 3 through a retaining element 34. The annular band elements 9, 9′ are again shrunk-fitted onto the rotating bearing rings 7, 7′ and fixedly connected to the intermediate element 32 in the axial direction by means of fixing pins 10, 10′. The rotating bearing rings 7, 7′ as well as the two bushings 30, 31 are again made of a ceramic material, and the intermediate element 32 and the two retaining elements 33, 34 as well as the shaft 3 are made of a metallic material, such that these components again have different thermal expansion coefficients. Also in this embodiment, the rotating bearing rings 7, 7′ and the annular band elements 9, 9′ again form an interconnected element 23 by means of shrinkage connections, which interconnected element is inserted into the intermediate element 32 with a centering snug-fit. A fixation of the interconnected element 23 in the axial direction for transmitting the torque occurs only through the fixing pins 10, 10′. Apart from this, the present embodiment corresponds to the preceding embodiment, such that reference can be made to the description given therein.

1. A bearing arrangement for supporting a shaft, comprising:
a) a bushing in which the shaft is received, a circumferential ring gap being present between the bushing and the shaft, and the bushing and the shaft being made of materials having different thermal expansion coefficients;
b) a connection arrangement comprising a retaining element connected to the shaft and a rotating bearing ring in order to provide a centering support of the bushing at the outer circumference thereof relative to the shaft;
c) a stationary bearing ring that is disposed radially outside of the bushing and forms an axial sliding bearing with the rotating bearing ring,
wherein;
the connection arrangement comprises a circumferential annular band element, wherein the annular band element is connected to the rotating bearing ring by means of a shrinkage connection in order to form an interconnected element, wherein the interconnected element is inserted in a recess of the retaining element with a centering snug fit, and the annular band element is connected to the retaining element in the axial direction (X-X) of the shaft.

2. The bearing arrangement of claim 1, wherein the annular band element is symmetric with an axis (A) that is arranged perpendicular to the axial direction (X-X) of the shaft.

3. The bearing arrangement of claim 1, wherein the bushing, the rotating bearing ring and the stationary bearing ring are made of a material having the same or a similar thermal expansion coefficient, in particular are made of SiC.

4. The bearing arrangement of claim 1, wherein the retaining element, the shaft and the annular band element are made of a material having the same or a similar thermal expansion coefficient, in particular are made of steel.

5. The bearing arrangement of claim 1, wherein the stationary bearing ring has a radial sliding surface and forms a radial sliding bearing together with a radial sliding surface of the bushing.

6. The bearing arrangement of claim 1, wherein two stationary bearing rings and two rotating bearing rings for forming a twin bearing arrangement.

7. The bearing arrangement of claim 6, wherein the rotating bearing rings are arranged at stationary bearing ring sides facing each other in the axial direction(X-X), or that the rotating bearing rings are arranged at stationary bearing ring sides facing away from each other in the axial direction (X-X).

8. A magnetic coupling, comprising a bearing arrangement as recited in claim 1.
